(19) United States
(12) Patent Application Publication
(10) Pub. No.: US 2014/0009377 A1
(43) Pub. Date: Jan. 9, 2014

(54) LIQUID CRYSTAL DISPLAY APPARATUS WITH PRIVATE MODE

(71) Applicants: Minoru SHIBAZAKI, Chu-Nan (TW); Yoshitaka HARUYAMA, Chu-Nan (TW)

(72) Inventors: Minoru SHIBAZAKI, Chu-Nan (TW); Yoshitaka HARUYAMA, Chu-Nan (TW)

(73) Assignees: CHIMEI INNOLUX CORPORATION, Chu-Nan (TW); INNOCOM TECHNOLOGY (SHENZHEN) CO., LTD., Shenzhen City (CN)

(21) Appl. No.: 13/544,348

(22) Filed: Jul. 9, 2012

(51) Int. Cl. G02F 1/13357; G09G 3/36; G02F 1/1347

(52) U.S. Cl. 345/102; 349/64

(57) ABSTRACT

A liquid crystal (LC) display apparatus includes a LC display panel for displaying data; a collimated backlight system disposed under the LC display panel; a scattering-type LC cell disposed between the LC display panel and the collimated backlight system; and a controller coupled to the LC display panel, the collimated backlight system and the scattering-type LC cell. A luminance of the collimated backlight system is adjustable by the controller. When the LC display apparatus is switched to be operated in the normal mode by the controller, the scattering-type LC cell is in an off-state and scatters the collimated light to present a wide brightness distribution. When the LC display apparatus is switched to be operated in the private mode by the controller, the scattering-type LC cell is in an on-state and the collimated light passes through the scattering-type LC cell to present a narrow brightness distribution.

### BACKGROUND

1. Technical Field

The disclosed embodiments relate in general to a liquid crystal (LC) display apparatus with private mode, and more particularly to a LC display apparatus with adjustable luminance of the backlight in the private mode.

2. Description of the Related Art

A liquid crystal display (LCD) is a flat panel display, electronic visual display, video display that uses the light modulating properties of liquid crystals (LCs). LCDs have displaced cathode ray tube (CRT) displays in most applications since they are more compact, lightweight, portable, less expensive, more reliable, and easier on the eyes. Today, LCDs are most commonly used displays and are available in a wide range of shapes, sizes, levels of quality and models, and are used in a wide range of applications, including computer monitors and television, and medium-sized instrument panels, aircraft cockpit displays, signage, and small-sized cellular phone, smart phone and PDA (personal digital assistant), etc.

In the general conditions, the LCD with wide viewing angle is a goal of design to allow a user viewing the image on the LCD at many different positions relative to the display, which are not only the front position (i.e. 0 degree of viewing angle) but also the positions with large angles skew from the front of the display. In some occasions, however, the user may not want the displayed data (such as displayed on the cellular phone, smart phone and PDA) to be seen by other people around, and the data security becomes one of the considerable issues for LCD design.

Currently, a LCD with switchable normal mode and private mode has been developed. The normal mode of LCD permits the displayed data to be viewed by anyone in a safe place, so that the user and people around the user at positions within the wide viewing angle range can identify the displayed data. The private mode of LCD prevents from undesired peep in a public space, so that people around the user cannot identify what is being displayed. 3M has proposed a light control film (Vikuiti™) as a shielding barrier attached on the top of LCD panel. The light control film has closely spaced black microlouvers that act like window blinds to control the direction of light transmission through the film, so that light can only go through the transparent areas of the light control film, and the black microlouvers limit the viewing angle. However, the microlouvers pattern of the light control film is not changeable, and low transmittance occurs due to light absorption by the material of the black microlouvers.

### SUMMARY

The disclosure is directed to more particularly to a liquid crystal (LC) display apparatus with private mode, which is capable of controlling the brightness distribution of the backlight, and the luminance of the backlight can be optionally adjusted, thereby reducing the power consumption of the LC display apparatus.

According to one aspect of the embodiment, a liquid crystal (LC) display apparatus is provided, including a LC display panel for displaying a data; a collimated backlight system disposed under the LC display panel for providing a collimated light towards the LC display panel; a scattering-type LC cell disposed between the LC display panel and the collimated backlight system; and a controller coupled to the LC display panel, the collimated backlight system and the scattering-type LC cell. The LC display apparatus can be switched to be operated in a normal mode or in a private mode by the controller, and a luminance of the collimated backlight system is also adjustable by the controller. When the LC display apparatus is switched to be operated in the normal mode, the scattering-type LC cell is in an off-state and the collimated light is scattered by the scattering-type LC cell to present a wide brightness distribution. When the LC display apparatus is switched to be operated in the private mode, the scattering-type LC cell is in an on-state and the collimated light passes through the scattering-type LC cell to present a narrow brightness distribution.

According to another aspect of the embodiment, a method for displaying a data on a liquid crystal (LC) display apparatus is provided. First, a LC display apparatus as described above is provided. Then, the LC display apparatus is switched to be operated in a normal mode or in a private mode by the controller, wherein if the LC display apparatus is switched to be operated in the normal mode, the scattering-type LC cell is in an off-state and the collimated light is scattered by the scattering-type LC cell to present a wide brightness distribution; and if the LC display apparatus is switched to be operated in the private mode, the scattering-type LC cell is in an on-state and the collimated light passes through the scattering-type LC cell to present a narrow brightness distribution. Next, the data is displayed on the LC display panel after determination of the normal mode or the private mode of the LC display apparatus.

The disclosure will become apparent from the following detailed description of the preferred but non-limiting embodiments. The following description is made with reference to the accompanying drawings.

### BRIEF DESCRIPTION OF THE DRAWINGS

FIG. 1 is a block diagram simply showing a liquid crystal (LC) display apparatus according to the embodiment of the present disclosure.

FIG. 2A illustrates the LC display apparatus of the embodiment operated in the normal mode.

FIG. 2B illustrates the LC display apparatus of the embodiment operated in the private mode.

FIG. 3 shows the brightness distributions of the scattering-type LC cell in the off-state and on-state without modulation according to the embodiment of the present disclosure.

FIG. 4 shows the brightness distributions of the scattering-type LC cell in the on-state without and with brightness modulation according to the embodiment of the present disclosure.

FIG. 5 illustrates one method of brightness modulations of the embodiment.

FIG. 6 illustrates another method of brightness modulations of the embodiment.

FIG. 7 is a plot illustrating the correlation of brightness to color-level or grey-level (signal voltage).

FIG. 8 is a schematic diagram illustrating the signal voltages applied to adjacent pixel elements when the LC display apparatus of the embodiment operated in the normal mode and private mode.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The embodiment of the present disclosure provides a liquid crystal (LC) display apparatus with private mode, which is capable of controlling the brightness distribution of the backlight, and the luminance of the backlight can be optionally adjusted, thereby reducing the power consumption of the LC display apparatus. The embodiments are provided to demonstrate, but not intended to limit, the display structures of the present disclosure. The modifications and variations can be made without departing from the spirit of the disclosure to meet the requirements of the practical applications.

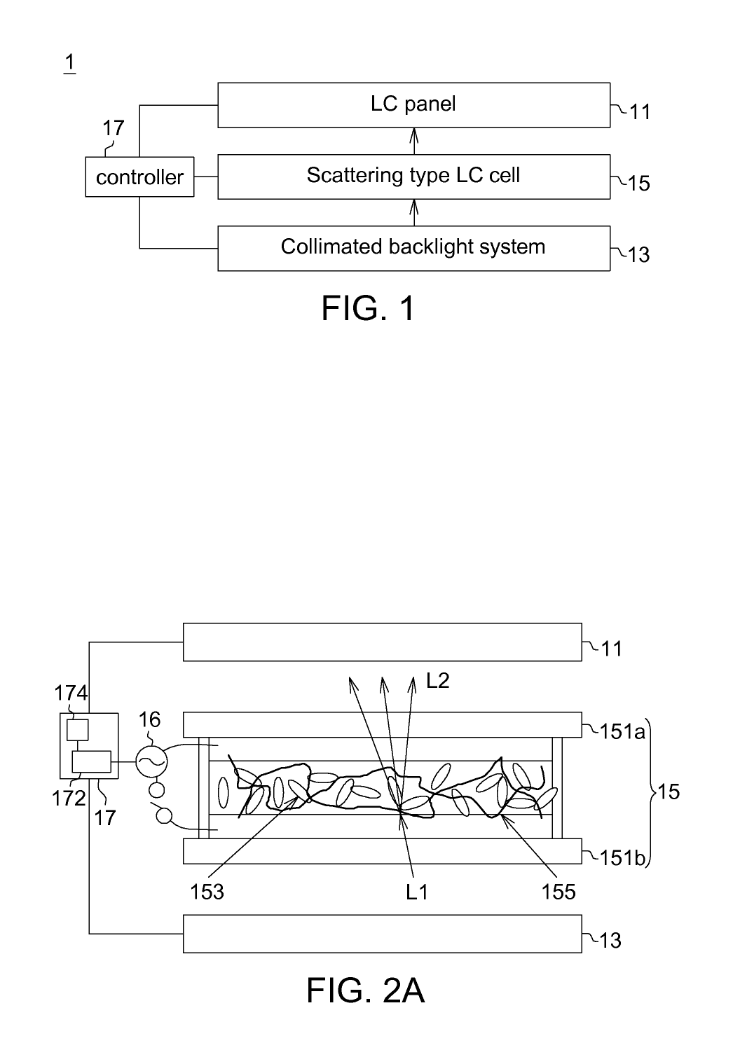

FIG. 1 is a block diagram simply showing a liquid crystal (LC) display apparatus according to the embodiment of the present disclosure. The liquid crystal (LC) display apparatus 1 includes a LC display panel 11 for displaying a data, a collimated backlight system 13 disposed under the LC display panel 11 for providing a collimated light towards the LC display panel 11, a scattering-type LC cell 15 disposed between the LC display panel and the collimated backlight system, and a controller 17 coupled to the LC display panel 11, the collimated backlight system 13 and the scattering-type LC cell 15. The controller 17 controls the LC display apparatus being operated in a normal mode or in a private mode, and whether a luminance of the collimated backlight system 13 is adjusted is controlled by the controller 17. In one embodiment, a full-width at half-maximum (FWHM) of the collimated backlight system is, but not limited to, in a range of −15 degree to +15 degree. The details of implementation are described below.

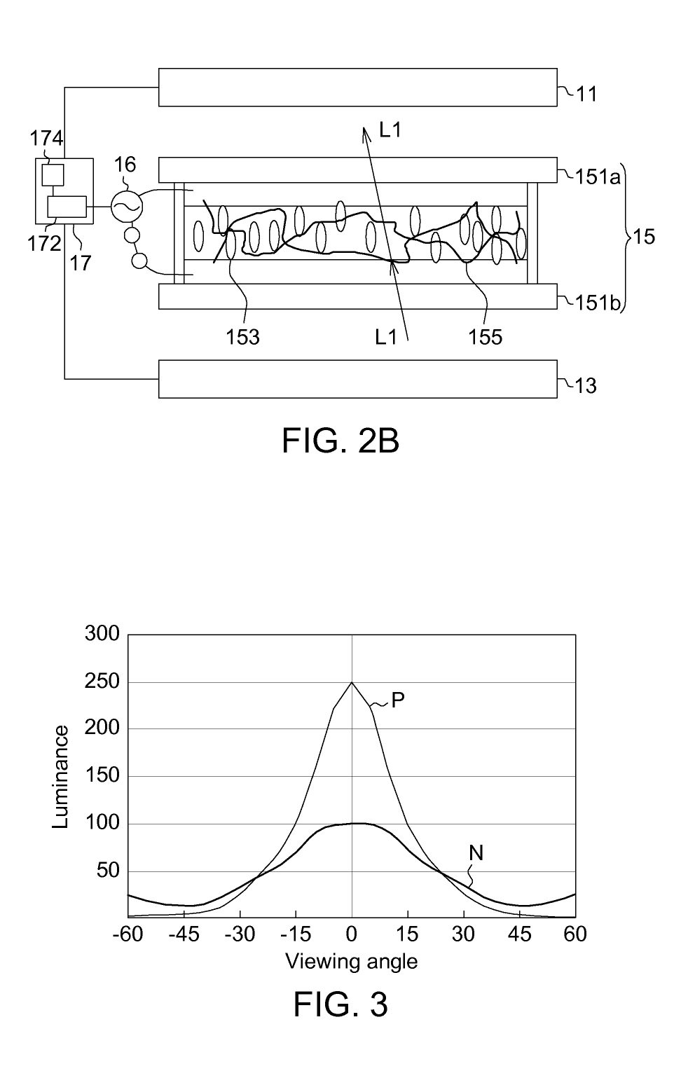

Please refer to FIG. 2A and FIG. 2B. The identical elements in FIG. 1, FIG. 2A and FIG. 2B retain the same reference numbers. FIG. 2A illustrates the LC display apparatus of the embodiment operated in the normal mode. FIG. 2B illustrates the LC display apparatus of the embodiment operated in the private mode. In one embodiment, the scattering-type LC cell 15 includes a LC layer sandwiched between a top substrate 151a and a bottom substrate 151b. One example of the scattering-type LC cell 15 includes a vertical aligned (VA) mode LC cell containing polymer-dispersed liquid crystals (PDLC) in the LC layer, which consists of plural micron-sized LC molecules 153 dispersed in a polymer network 155. The polymer network 155 is used for improving the response time of the VA mode LC cell.

When the LC display apparatus 1 is switched to be operated in the normal mode, the scattering-type LC cell 15 is in an off-state and the collimated light L1 from the collimated backlight system 13 is scattered by the scattering-type LC cell 15, as shown in FIG. 2A. In one embodiment, the LC display apparatus further comprises a power source 16 coupled to the controller 17 and the scattering-type LC cell 15 for applying a voltage to the scattering-type LC cell. Scattering property of scattering type LC cell 15 can be controlled by driving voltage. If the LC display apparatus is operated in the normal mode, no voltage or small voltage (such as 0V to 2V) is applied to the scattering-type LC cell 15. When the scattering-type LC cell 15 is in an off-state, the LC molecules 153 normally have random orientations, and their sizes are close to the visible wavelengths. The collimated light L1 from the collimated backlight system 13 is strongly scattered by the PDLC because of the refractive index mismatch between the LC molecules 153 and the polymer network 155.

When the LC display apparatus is switched to be operated in the private mode, the scattering-type LC cell 15 is in an on-state and the collimated light L1 passes through the scattering-type LC cell 15, as shown in FIG. 2B. In one embodiment, if the LC display apparatus is operated in the private mode, the voltage applied to the scattering-type LC cell is in a range of 2 to 10V. When the scattering-type LC cell 15 is in an on-state, the LC molecules 153 are reoriented along the applied electric field. The scattering-type LC cell 15 is transparent to the incident light (i.e. the collimated light L1) because the refractive index of the polymer network 155 is closed to the ordinary refractive index of the LC molecules 153. Therefore, in the PDLC the incoming collimated light L1 could be modulated by changing the orientation of the LC molecule 153 with an electric field.

FIG. 3 shows the brightness distributions of the scattering-type LC cell in the off-state and on-state without modulation according to the embodiment of the present disclosure. According to the illustration of FIG. 2A, the scattering-type LC cell 15 is in a scattering mode (i.e. off-state) when the LC display apparatus 1 is operated in the normal mode. Curve N of FIG. 3 represents the brightness distribution of the off-state scattering-type LC cell 15, which presents a wide brightness distribution. Therefore, when the LC display apparatus is switched to be operated in the normal mode, the scattering light L2 is provided for the LC display panel 11 as the light source, and the LC display panel 11 displays the data with a wide viewing angle.

According to the illustration of FIG. 2B, the scattering-type LC cell 15 is in a transparent mode (i.e. on-state) when the LC display apparatus 1 is operated in the private mode. Curve P of FIG. 3 represents the brightness distribution of the on-state scattering-type LC cell 15, which presents a narrow brightness distribution with high brightness value at the normal direction (i.e. 0 degree of viewing angle). Therefore, when the LC display apparatus is switched to be operated in the private mode, the collimated light L1 is provided for the LC display panel 11 as the light source, and the LC display panel 11 displays the data with a narrow viewing angle, which prevents the peeping issue.

In the embodiment, the luminance of the collimated backlight system 13 could be optionally modulated, depending on the practical requirements of applications. It is indicated in FIG. 3 that the brightness of the private mode (curve P) of the LC display apparatus 1 is higher than the brightness of the normal mode (curve N) without modulation, especially in ±15 degree of the viewing angle. In the normal direction, e.g., 0 degree of viewing angle, the luminance of the private mode is 2.5 times of the luminance of the normal mode. In one practical condition, the product adopting the LC display apparatus of embodiment, such as mobile phone or smart phone, may directly projects the data image on a plane (functioning as a small projector) or to be a flashlight in the dark by switching the scattering-type LC cell 15 to the on-state (i.e. transparent mode) without processing brightness modulation.

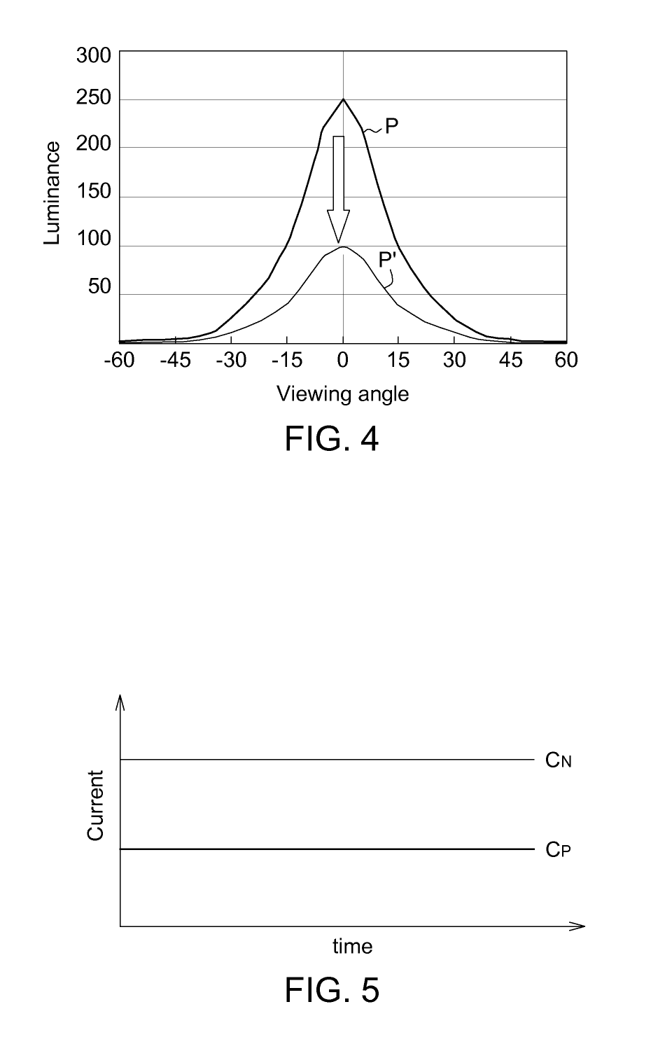

In some practical conditions, the brightness modulation can be performed by decreasing the luminance of the collimated backlight system 13 when the LC display apparatus 1 is operated in the private mode, so as to reduce the power consumption of the collimated backlight system 13. FIG. 4 shows the brightness distributions of the scattering-type LC cell in the on-state without and with brightness modulation according to the embodiment of the present disclosure. Curve P of FIG. 4 (and FIG. 3) represents the brightness distribution of the on-state scattering-type LC cell 15 without brightness modulation. Curve P′ of FIG. 4 represents an adjusted brightness distribution of the on-state scattering-type LC cell 15 after brightness modulation. The disclosure has no particular limitation on the extent of brightness modulation. In one embodiment, the luminance of the collimated backlight system 13 in the on-state can be adjusted to be substantially the same as that in the off-state. For example, 250 of the luminance in the private mode at 0 degree of viewing angle (peak of curve P) is decreased to about 100 (peaks of curves P′ and N), as shown in FIG. 4 and FIG. 3, thereby saving the backlight power.

In one embodiment, the scattering-type LC cell 15 and the luminance of the collimated backlight system 13 are independently controlled by the controller 17. As shown in FIG. 2A and FIG. 2B, the controller 17 could comprise a luminance adjusting unit 172 and a selection unit 174. The luminance adjusting unit 172 is coupled to the collimated backlight system 13 to adjust the luminance of the collimated backlight system 13. The selection unit 174 is coupled to the luminance adjusting unit 172 to determine whether the luminance adjusting unit 174 is activated. In one embodiment, a button on the controller 17 or selection through an operation list shown on a display window or other implementations could be adopted to turn the private mode on and off, and also to activate the luminance adjusting unit 174. The disclosure has no limitation thereto. In the private mode, whether the brightness modulation is performed to adjust the luminance of the collimated backlight system 13 is optionally determined according to actual needs of applications.

Several methods could be adopted, but not the limitations, for the implementation of brightness modulation. One of the applicable methods is to control the current values for the collimated backlight system 13. FIG. 5 illustrates one method of brightness modulations of the embodiment. The luminance adjusting unit 172 adjusts the luminance of the collimated backlight system 13 by controlling a first current C_{N} and a second current C_{P} to drive the collimated backlight system 13 respectively in the normal mode and the private mode of the LC display apparatus 1, and the first current C_{N} is larger than the second current C_{P}. The first current C_{N} and the second current C_{P} could be the constant values which don't change with time. For example, about 20 mA (e.g. the first current) is applied for driving the collimated backlight system 13 when the LC display apparatus is operated in the normal mode, and about 10 mA (e.g. the second current) is applied for driving the collimated backlight system 13 when the LC display apparatus is operated in the private mode. It is noted that those voltage values are merely for demonstration, not for limitation, and could be selected according to the actual needs of applications.

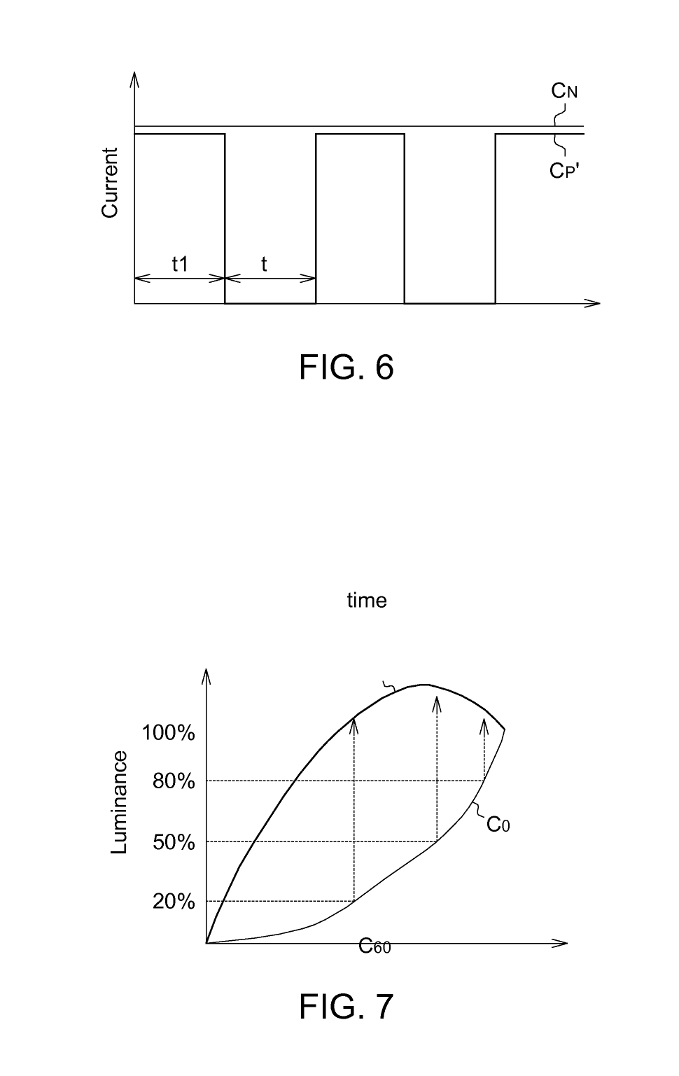

Another one of the applicable methods is to control the current pulses for the collimated backlight system 13. FIG. 6 illustrates another method of brightness modulations of the embodiment. The luminance adjusting unit 172 adjusts the luminance of the collimated backlight system 13 by driving the collimated backlight system 13 with a steady current and a current pulse respectively in the normal mode and the private mode of the LC display apparatus 1. As shown in FIG. 6, a first current C_{N} with a constant value is steadily applied to drive the collimated backlight system 13 when the LC display apparatus is operated in the normal mode, and an on-and-off current pulse C_{P}′, such as the alternate on-current and off-current, applied to drive the collimated backlight system 13 when the LC display apparatus is operated in the private mode. In the embodiment, the on-current duration time t1 and the off-current duration time t2 could be identical; and also, the on-current value of the on-and-off current pulse C_{P}′ is close to the value of the first current C_{N}.

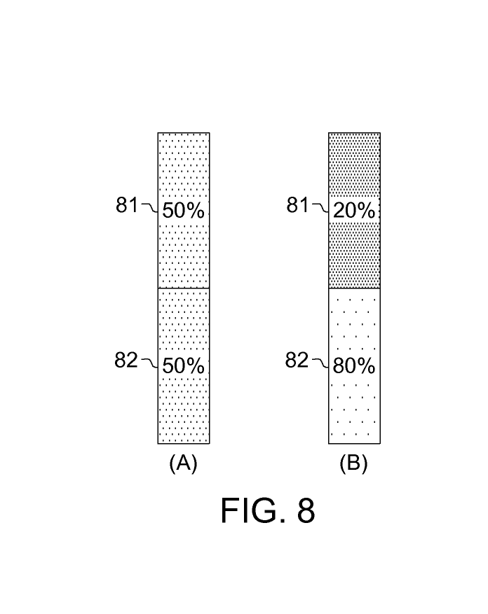

Moreover, the LC display panel 11 with a peeping-preventing function could be further incorporated in the embodiment. Please refer to FIG. 7 and FIG. 8. FIG. 7 is a plot illustrating the correlation of brightness to color-level or grey-level (signal voltage). FIG. 8 is a schematic diagram illustrating the signal voltages applied to adjacent pixel elements when the LC display apparatus of the embodiment operated in the normal mode and private mode. The presented curves are so-called as γ (gamma)-curves, wherein Curve C₀ is a typical γ (gamma)-curve at 0-degree of the viewing angle (e.g. viewing from the normal direction), and brightness generally increases with signal voltage in an exponential order. Curve C₆₀ shows the brightness vs. color-level or grey-level variation at 60-degree of the viewing angle skew from the front. It can also be seen from FIG. 7 that a pixel or sub-pixel shows two different values of brightness in two viewing cases, one is the resulting brightness viewed at a normal position (i.e. right from the front, Curve C₀) and the other is the resulting brightness viewed a 60-degree skew position (Curve C₆₀). In other words, Curve 1 shows the variation of brightness with the applied voltage when viewed right from the front while Curve 2 shows the variation of brightness with the applied voltage when viewed at a 60-degree angle skew from the front. Accordingly, for the same image, brightness is changed as a whole with the viewing positions. The image viewed at an angle skew from the front, although becoming dark, may still be identifiable.

In one embodiment, the LC display panel 11 may include a pixel array comprising a plurality of pixel elements and a voltage source for supplying signal voltages to the pixel array for controlling brightness of the pixel array and displaying a data image. Different levels of the signal voltages are applied to adjacent pixel elements, respectively, so that an averaged brightness of the adjacent elements varies with the signal voltages following a γ-curve to show an expected data image when viewed at a normal position in front of the LC display panel 11, and the averaged brightness is at a constant level within a specified signal-voltage range to change a contrast of the data image to a visibly unidentifiable degree when viewed at a skew position from the front of the LC display panel 11. As shown in FIG. 8, when the LC display apparatus is operated in the normal mode, the adjacent pixel-1 81 and pixel-2 82 (or subpixels) are applied with voltages V1 and V2 to exhibit 50% and 50% of brightness, respectively. The brightness of the pixel set (A), defined by an average of the two pixels (81 and 82), is 50%. When the LC display apparatus is operated in the private mode the adjacent pixel-1 81 and pixel-2 82 (or subpixels) are applied with voltages V1 and V2 to exhibit 20% and 80% of brightness, respectively. Although the brightness of the pixel set (B) defined by an average of the two pixels (81 and 82) is still 50% (i.e. (20+80)/2), relatively high brightness zones (e.g. 80%) and relatively low brightness zones (e.g. 20%) of plural pixel sets of the LC display panel 11 alternately appear when viewed at a skew angle (such as 60 degree of viewing angle), so as to conduct shaded effects and thus make the displayed data image visibly unidentifiable.

According to the aforementioned description of the embodiments, the private mode of the LC display apparatus could be realized by disposing a scattering-type LC cell between a LC display panel and a collimated backlight system, and by controlling the brightness distribution of backlight. Also, the luminance of the collimated backlight system being adjustable by a controller. When the LC display apparatus is operated in the private mode to exhibit the narrow viewing angle, the luminance of the collimated backlight system could be optionally decreased, so as to reduce the power consumption. In this way, a wide-viewing-angle normal mode and a narrow-viewing-angle private mode with low power of the LC display apparatus can be realized according to the present embodiment. The implementations of luminance adjustment could be optionally selected and varied, depending on designs of applications.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A liquid crystal (LC) display apparatus, comprising:
a LC display panel for displaying a data;
a collimated backlight system, disposed under the LC display panel for providing a collimated light towards the LC display panel;
a scattering-type LC cell disposed between the LC display panel and the collimated backlight system; and
a controller, coupled to the LC display panel, the collimated backlight system and the scattering-type LC cell, to control the LC display apparatus being operated in a normal mode or in a private mode, and to adjust a luminance of the collimated backlight system;
when the LC display apparatus being operated in the normal mode, the scattering-type LC cell is in an off-state and the collimated light is scattered by the scattering-type LC cell to present a wide brightness distribution; and
when the LC display apparatus being operated in the private mode, the scattering-type LC cell is in an on-state and the collimated light passes through the scattering-type LC cell to present a narrow brightness distribution.

2. The LC display apparatus according to claim 1, wherein when the LC display apparatus is operated in the normal mode, the LC display panel displays the data with a wide viewing angle, and when the LC display apparatus is operated in the private mode, the LC display panel displays the data with a narrow viewing angle.

3. The LC display apparatus according to claim 1, wherein a full-width at half-maximum (FWHM) of the collimated backlight system is in a range of −15 degree to +15 degree.

4. The LC display apparatus according to claim 1, further comprising a power source coupled to the controller and the scattering-type LC cell, for applying a voltage to the scattering-type LC cell.

5. The LC display apparatus according to claim 4, wherein when the LC display apparatus is operated in the normal mode, the voltage applied to the scattering-type LC cell is in a range of 0 to 2V.

6. The LC display apparatus according to claim 4, wherein when the LC display apparatus is operated in the private mode, the voltage applied to the scattering-type LC cell is in a range of 2 to 10V.

7. The LC display apparatus according to claim 1, wherein the brightness of the private mode of the LC display apparatus is higher than that of the normal mode.

8. The LC display apparatus according to claim 1, wherein the controller comprises a luminance adjusting unit coupled to the collimated backlight system to adjust the luminance of the collimated backlight system.

9. The LC display apparatus according to claim 8, wherein the luminance of the collimated backlight system in the on-state is adjusted by the luminance adjusting unit to be substantially the same as that in the off-state.

10. The LC display apparatus according to claim 8, wherein the luminance adjusting unit decreases the luminance of the collimated backlight system when the LC display apparatus is operated in the private mode.

11. The LC display apparatus according to claim 8, wherein the luminance adjusting unit adjusts the luminance of the collimated backlight system by controlling a first current and a second current to drive the collimated backlight system respectively in the normal mode and the private mode of the LC display apparatus, and the first current is larger than the second current.

12. The LC display apparatus according to claim 8, wherein the luminance adjusting unit adjusts the luminance of the collimated backlight system by driving the collimated backlight system with a steady current and a on-and-off current pulse when the LC display apparatus is operated in the normal mode and the private mode, respectively.

13. The LC display apparatus according to claim 8, wherein the controller further comprises a selection unit coupled to the luminance adjusting unit to determine whether the luminance adjusting unit is activated.

14. The LC display apparatus according to claim 1, wherein the scattering-type LC cell and the luminance of the collimated backlight system are independently controlled by the controller.

15. The LC display apparatus according to claim 1, wherein when the LC display apparatus is operated in the normal mode, the scattering-type LC cell is in a scattering mode, and when the LC display apparatus is operated in the private mode, the scattering-type LC cell is in a transparent mode.

16. A method for displaying a data on a liquid crystal (LC) display apparatus, comprising:
providing the LC display apparatus comprising a LC display panel, a collimated backlight system disposed under the LC display panel for providing a collimated light, a scattering-type LC cell disposed between the LC display panel and the collimated backlight system, and a controller coupled to the LC display panel, the collimated backlight system and the scattering-type LC cell, wherein the controller controls the LC display apparatus being operated in a normal mode or in a private mode, and a luminance of the collimated backlight system is adjustable by the controller;
switching the LC display apparatus to be operated in a normal mode or in a private mode by the controller, wherein if the LC display apparatus is switched to be operated in the normal mode, the scattering-type LC cell is in an off-state and the collimated light is scattered by the scattering-type LC cell to present a wide brightness distribution; and if the LC display apparatus is switched to be operated in the private mode, the scattering-type LC cell is in an on-state and the collimated light passes through the scattering-type LC cell to present a narrow brightness distribution; and
displaying the data on the LC display panel after determination of the normal mode or the private mode of the LC display apparatus.

17. The method according to claim 16, wherein the controller comprises a luminance adjusting unit coupled to the collimated backlight system, and the method further comprises adjusting the luminance of the collimated backlight system before displaying the data.

18. The method according to claim 17, further comprising adjusting the luminance of the collimated backlight system in the on-state by the luminance adjusting unit to be substantially the same as that in the off-state before displaying the data.

19. The method according to claim 17, further comprising decreasing the luminance of the collimated backlight system before displaying the data when the LC display apparatus is switched to be operated in the private mode.

20. The method according to claim 17, further comprising controlling a first current and a second current to drive the collimated backlight system by the luminance adjusting unit while the LC display apparatus are respectively switched to be operated in the normal mode and in the private mode, wherein the first current is larger than the second current.

21. The method according to claim 17, further comprising adjusting the luminance of the collimated backlight system by the luminance adjusting unit to drive the collimated backlight system with a steady current and a on-and-off current pulse when the LC display apparatus is operated in the normal mode and the private mode, respectively.

22. The method according to claim 17, wherein the controller further comprises a selection unit coupled to the luminance adjusting unit, and the method further comprises step of determining whether the luminance adjusting unit is activated by the selection unit.

23. The method according to claim 16, wherein the scattering-type LC cell and the luminance of the collimated backlight system are independently controlled by the controller.

24. The method according to claim 16, wherein the LC display apparatus further comprises a power source coupled to the controller and the scattering-type LC cell, and the method further comprises step of applying a voltage to the scattering-type LC cell by the power source.

25. The method according to claim 16, wherein when the LC display apparatus is switched to be operated in the normal mode, the method further comprises switching the scattering-type LC cell to a scattering mode by the controller, and when the LC display apparatus is switched to be operated in the private mode, the method further comprises switching the scattering-type LC cell to a transparent mode.
